(19) United States
(12) Patent Application Publication
(10) Pub. No.: US 2026/0111829 A1
(43) Pub. Date: Apr. 23, 2026

(54) Methods, Systems and Computer Program Products for Determining Models for Predicting Reoccurring Transactions

(71) Applicant: Xero Limited, Te Aro, Wellington (NZ)

(72) Inventors: Danny Doan, Te Aro, Wellington (NZ); Allen Qin, Te Aro, Wellington (NZ); Rebecca Dridan, Te Aro, Wellington (NZ); Soon-Ee Cheah, Te Aro, Wellington (NZ)

(21) Appl. No.: 18/869,659

(22) PCT Filed: Apr. 24, 2023
(86) PCT No.: PCT/NZ2023/050045

§ 371 Date: Nov. 26, 2024

(30) Foreign Application Priority Data
May 27, 2022 (AU) 2022901440
Nov. 30, 2022 (WO) PCT/NZ2022/050161

(51) Int. Cl. G06Q 10/067

(52) U.S. Cl. CPC G06Q 10/067

(57) ABSTRACT

A computer-implemented method for generating a model of periodic transactions based on the cluster of transactions comprises determining a dataset of transactions occurring during a first time period, and determining a subset of related transactions from the dataset of transactions. The method comprises selecting a first transaction interval pattern, selecting a first clustering criteria, the first clustering criteria comprising a threshold deviation from the first transaction interval pattern, and based on the first transaction interval pattern and the first clustering criteria, identifying a cluster of transactions from the subset of related transactions. Identifying the cluster of transactions comprises: determining an interval difference between the dates of at least one pair of transactions in the subset of related transactions; and determining the cluster of transactions as the transactions of the subset of related transactions that comply with the first transaction interval pattern and the threshold deviation from first transaction interval pattern.

### TECHNICAL FIELD

Described embodiments relate to methods, systems and computer program products for determining reoccurring transactions, which may be used to predict, for example. Some described embodiments relate to methods, systems and computer program products for determining model(s) for determining reoccurring transactions.

### BACKGROUND

Many businesses that fail do so because of cash flow problems. As a result, effectively predicting future cash flow is important to businesses and trading entities, enabling them to ensure adequate access to funds necessary for operational expenses while making sure that the entity's assets are invested in the most financially productive manner.

However, cash flow over a given time period can be dependent on a wide range of factors including outstanding receivables, obsolete inventory, cost of short term debt, payment obligations, liquidity and trading obligations of trading partner entities, and short term investment yields. Taking into account the large range of dynamic factors is a computationally complex, time and labour intensive operation, and can be an arduous and error prone process.

It is desired to address or ameliorate some of the disadvantages associated with prior methods and systems for predicting cash flow, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer-implemented method comprising: determining a dataset of transactions occurring during a first time period; determining a subset of related transactions from the dataset of transactions, where each transaction in the subset of related transactions shares at least one common attribute; selecting a first transaction interval pattern; selecting a first clustering criteria, wherein the first clustering criteria comprises a threshold deviation from the first transaction interval pattern; based on the first transaction interval pattern and the first clustering criteria, identifying a cluster of transactions from the subset of related transactions; wherein identifying the cluster of transactions from the subset of related transactions comprises: determining an interval difference between the dates of at least one pair of transactions in the subset of related transactions, and wherein each of the at least one pair of transactions comprises a first date having a first day and a first month, and a second date having a second day and a second month; and determining the cluster of transactions as the transactions of the subset of related transactions that comply with the first transaction interval pattern and the threshold deviation from first transaction interval pattern; and wherein determining the interval difference between the dates of at least one pair of transactions comprises: determining a first interval difference value comprising a difference between the first day of the second month and the second day of the second month; determining a second interval difference value comprising a difference between the second day of the first month and the first day of the first month; determining a third interval difference value comprising a difference between the first day of the month following the first month and the second day of the second month; determining a fourth interval difference value comprising a difference between the first day of the first month and the second day of the month immediately preceding the second month; and determining the interval difference based on the first interval difference value, the second interval difference value, the third interval difference value and the fourth interval difference value; and generating a model of periodic transactions based on the cluster of transactions, the model including an interval related to the first transaction interval pattern, and a common model attribute based on the at least one common attribute. The method may be a computer-implemented method.

Some embodiments relate to a computer-implemented method comprising: determining a dataset of transactions occurring during a first time period; determining a subset of related transactions from the dataset of transactions, where each transaction in the subset of related transactions shares at least one common attribute; selecting a first transaction interval pattern; selecting a first clustering criteria, wherein the first clustering criteria comprises a threshold deviation from the first transaction interval pattern; based on the first transaction interval pattern and the first clustering criteria, identifying a cluster of transactions from the subset of related transactions; wherein identifying the cluster of transactions from the subset of related transactions comprises: calculating an interval difference between the dates of at least one pair of transactions in the subset of related transactions; and determining the cluster of transactions as the transactions of the subset of related transactions that comply with the first transaction interval pattern and the threshold deviation from first transaction interval pattern; and generating a model of periodic transactions based on the cluster of transactions, the model including an interval related to the first transaction interval pattern, and a common model attribute based on the at least one common attribute.

In some embodiments, weekend days are discounted from contributing to the interval difference.

In some embodiments, determining or calculating the interval difference between the dates of at least one pair of transactions in the subset of related transactions comprises, for each pair of the at least one pair of transactions: determining a first date of a first transaction of the pair, the first date comprising a first day and a first month; determining a second date of a second transaction of the pair, the second date comprising a second day and a second month; and determining the interval difference based on the first date and the second date of the pair of transactions. For example, determining or calculating the interval difference based on the first date and the second date of the pair of transactions comprises: determining a first interval difference value comprising a difference between the first day of the second month and the second day of the second month; determining a second interval difference value comprising a difference between the second day of the first month and the first day of the first month; and determining the interval difference based on the first interval deviation value and the second interval deviation value. In some examples, determining or calculating the interval difference based on the first date and the second date of the pair of transactions comprises: determining a third interval difference value comprising a difference between the first day of the month following the first month and the second day of the second month; determining a fourth interval difference value comprising a difference between the first day of the first month and the second day of the month immediately preceding the second month; and determining the interval difference based on the third interval deviation value and the fourth interval deviation value.

Determining the interval difference may comprise determining a minimum of the first interval deviation value and the second interval deviation value. Determining the interval difference may comprise determining a minimum of the third interval deviation value and the fourth interval deviation value as the interval difference. Determining the interval difference may comprise determining a minimum of the first interval deviation value, the second interval deviation value, the third interval deviation value and the fourth interval deviation value as the interval difference.

Some embodiments relate to a computer-implemented method comprising: determining a dataset of transactions occurring during a first time period; determining a subset of related transactions from the dataset of transactions, where each transaction in the subset of related transactions shares at least one common attribute; selecting a first transaction interval pattern; selecting a first clustering criteria; based on the first transaction interval pattern and the first clustering criteria, identifying one or more clusters of transactions from the subset of related transactions; wherein identifying one or more clusters of transactions from the subset of related transactions comprises: determining an interval difference set comprising an interval difference between the dates of at least a plurality of pairs of transactions in the subset of related transactions; determining that the interval difference for two or more contiguous transactions of the interval difference set is less than a minimum threshold interval difference; determining one or more interval difference subsets of the interval difference set, wherein each of the one or more interval difference subsets is not associated with more than one transaction for any given date, and the transactions of the one or more interval difference subsets comply with the first transaction interval pattern; and determining the one or more clusters of transactions as the transactions associated with the respective one or more interval difference subsets; and generating one or more models of periodic transactions based on the respective one of more clusters of transactions, the model including an interval related to the first transaction interval pattern, and a common model attribute based on the at least one common attribute. The one or more interval difference subsets may be mutually exclusive in terms of the transactions they represent.

The interval difference set may be a rounded interval difference set, wherein the individual transactions intervals are rounded to the base value.

In some embodiments, the method further comprises performing a viability check on the cluster; and in response to the cluster passing the viability check, generating the model of periodic transactions.

In some embodiments, the method further comprises marking the transactions of the cluster as used. In some embodiments, the method further comprises
selecting a second clustering criteria, the second clustering criteria being more lenient than the first clustering criteria; based on the first transaction interval pattern and the second clustering criteria, identifying a second cluster of transactions from the subset of related transactions that are not marked as used; performing a viability check on the second cluster; and in response to the second cluster passing the viability check, generating a model of periodic transactions, the model including an interval related to the first transaction interval pattern, and a common attribute based on the at least one common attribute. In some embodiments, the method further comprises selecting a second transaction interval pattern, the second transaction interval pattern being longer in duration than the first transaction interval pattern; based on the second transaction interval pattern and the first clustering criteria, identifying a further cluster of transactions from the subset of related transactions that are not marked as used; performing a viability check on the further cluster; and in response to the further cluster passing the viability check, generating a model of periodic transactions, the model including an interval related to the second transaction interval pattern, and a common attribute based on the at least one common attribute.

In some embodiments, the method comprises using the model of periodic transactions to predict at least one future recurring transaction having an interval related to the second transaction interval pattern and a common attribute based on the at least one common attribute.

In some embodiments, performing a viability check on the cluster comprises checking one or more of: the recency of the latest transaction in the cluster; the extent to which the individual transaction intervals of the cluster match a determined pattern; and the number of unique transactions in the cluster.

Some embodiments relate to a system comprising: one or more processors; and memory comprising computer executable instructions, which when executed by the one or more processors, cause the system to perform the method of any one of the described embodiments.

Some embodiments relate to a non-transitory machine-readable medium storing instructions which, when executed by one or more processors, cause a computing device to perform the method of any one of the described embodiments.

Some embodiments relate to a computer-implemented method comprising: determining a dataset of transactions occurring during a first time period; determining a subset of related transactions from the dataset of transactions, where each transaction in the subset of related transactions shares at least one common attribute; selecting a first transaction interval pattern; selecting a first clustering criteria; based on the first transaction interval pattern and the first clustering criteria, identifying a cluster of transactions from the subset of related transactions; performing a viability check on the cluster; and in response to the cluster passing the viability check, generating a model of periodic transactions, the model including an interval related to the first transaction interval pattern; and a common attribute based on the at least one common attribute. Some embodiments further comprise marking the transactions of the cluster as used. Some embodiments further comprise: selecting a second clustering criteria, the second clustering criteria being more lenient than the first clustering criteria; based on the first transaction interval pattern and the second clustering criteria, identifying a second cluster of transactions from the subset of related transactions that are not marked as used; performing a viability check on the second cluster; and in response to the second cluster passing the viability check, generating a model of periodic transactions, the model including an interval related to the first transaction interval pattern; and a common attribute based on the at least one common attribute.

Some embodiments further comprise: selecting a second transaction interval pattern, the second transaction interval pattern being longer in duration than the first transaction interval pattern; based on the second transaction interval pattern and the first clustering criteria, identifying a further cluster of transactions from the subset of related transactions that are not marked as used; performing a viability check on the further cluster; and in response to the further cluster passing the viability check, generating a model of periodic transactions, the model including an interval related to the second transaction interval pattern; and a common attribute based on the at least one common attribute.

Some embodiments further comprise, prior to performing the clustering step, filtering the subset of related transactions based on at least one filtering criteria. According to some embodiments, the filtering criteria is a minimum transaction amount. Some embodiments further comprise using the model of periodic transactions to predict at least one future recurring transaction having an interval related to the second transaction interval pattern and a common attribute based on the at least one common attribute. According to some embodiments, performing a viability check on the cluster comprises checking one or more of: the recency of the latest transaction in the cluster; the extent to which the individual transaction intervals of the cluster match a determined pattern; and the number of unique transactions in the cluster. In some embodiments, checking the recency of the latest transaction in the cluster comprises determining the latest transaction in the cluster, determining the difference between the date of the latest transaction and the current date, and determining if the difference is less than a predetermined threshold, wherein where the difference is more than the predetermined threshold the cluster is determined to be unviable. In some embodiments, checking the extent to which the individual transaction intervals of the cluster match a determined pattern comprises determining individual transaction intervals by calculating the difference between each transaction and a next occurring transaction; determining a median transaction interval, and comparing the median transaction interval with the interval related to the selected transaction interval pattern; wherein where the median transaction interval does not match the selected transaction interval pattern, the cluster is determined to be unviable.

According to some embodiments, the median transaction interval is a binned median transaction interval, and wherein the binned median transaction interval is calculated by determining individual transaction intervals by calculating the difference between each transaction and a next occurring transaction; rounding each individual transaction interval to the nearest multiple of the selected transaction interval pattern; counting the number of instances of each rounded transaction interval; and determining the binned median transaction interval to be the rounded transaction interval with the highest count.

In some embodiments, checking the number of unique transactions in the cluster comprises determining whether the number of transactions in the cluster is more than a predetermined threshold, wherein where the difference is less than the predetermined threshold the cluster is determined to be unviable. According to some embodiments, performing a viability check on the cluster comprises performing an interval check, and wherein performing the interval check comprises: determining individual transaction intervals by calculating the difference between each transaction and a next occurring transaction; and determining whether less than half of the individual transaction intervals are zero; wherein if more than half of the rounded individual transaction intervals are zero the cluster is determined to be unviable. Some embodiments further comprise rounding each individual transaction interval to the nearest multiple of the selected transaction interval pattern before determining whether less than half of the individual transaction intervals are zero. According to some embodiments, the common attribute is at least one of a common transacting entity; a common bank account name, number or type; a common transaction amount; a common contact name or contact identifier such as business registration number, and/or a common contact address. In some embodiments, the interval pattern is selected from the group: weekly, fortnightly, monthly, quarterly and yearly. According to some embodiments, the clustering criteria comprises at least one of a deviation from the selected interval pattern, a difference in transaction amount, and a minimum number of transactions to be clustered. According to some embodiments, identifying a cluster of transactions from the subset of related transactions based on the first transaction interval pattern comprises calculating an interval difference between at least one pair of transactions in the subset of related transactions.

In some embodiments, calculating an interval difference comprises determining a difference in the day of the month on which the pair of transactions took place. In some embodiments, calculating an interval difference comprises determining a difference in the day of the week on which the pair of transactions took place. In some embodiments, determining a difference comprises mapping the days to a circle and determining the shortest number of steps between the days corresponding to the pair of transactions. In some embodiments, calculating an interval difference comprises mapping the date of the transaction to a trigonometric function, and determining a difference in the trigonometric value corresponding to the dates on which the pair of transactions took place.

Some embodiments relate to a computer-readable medium storing executable instructions which, when executed by a processor, perform the method of some other embodiments.

Some embodiments relate to a computing device comprising the computer-readable medium of some other embodiments and a processor configured to access and execute the instructions stored on the computer-readable medium.

### BRIEF DESCRIPTION OF DRAWINGS

Various ones of the appended drawings merely illustrate example embodiments of the present disclosure and cannot be considered as limiting its scope.

FIG. 1 is a schematic of a process for using a capital management platform to predict cash flow of an entity, according to some embodiments;

FIG. 2 is an example screenshot of a visual display provided by the cash flow forecast engine shown in FIG. 1, according to some embodiments;

FIG. 3 is a process flow diagram of a method for forecasting cash flow for an entity, according to some embodiments;

FIG. 4 is a process flow diagram of a method for generating models for predicting recurring transactions associated with entities, according to some embodiments;

FIG. 5 is a process flow diagram of a method for determining a subset of related transactions from a dataset of transactions, according to some embodiments;

FIGS. 6A and 6B are process flow diagrams of methods for determining interval difference or transaction interval deviations between dates of pairs of transactions, according to some embodiments;

FIG. 7 is a process flow diagram of a method for determining one or more clusters of transactions from a subset of related transactions, according to some embodiments;

FIG. 8 is a block diagram depicting an example application framework, according to some embodiments;

FIG. 9 is a block diagram depicting an example hosting infrastructure, according to some embodiments;

FIG. 10 is a block diagram depicting an example data centre system for implementing described embodiments; and

FIG. 11 is a block diagram illustrating an example of a machine arranged to implement one or more described embodiments.

### DESCRIPTION OF EMBODIMENTS

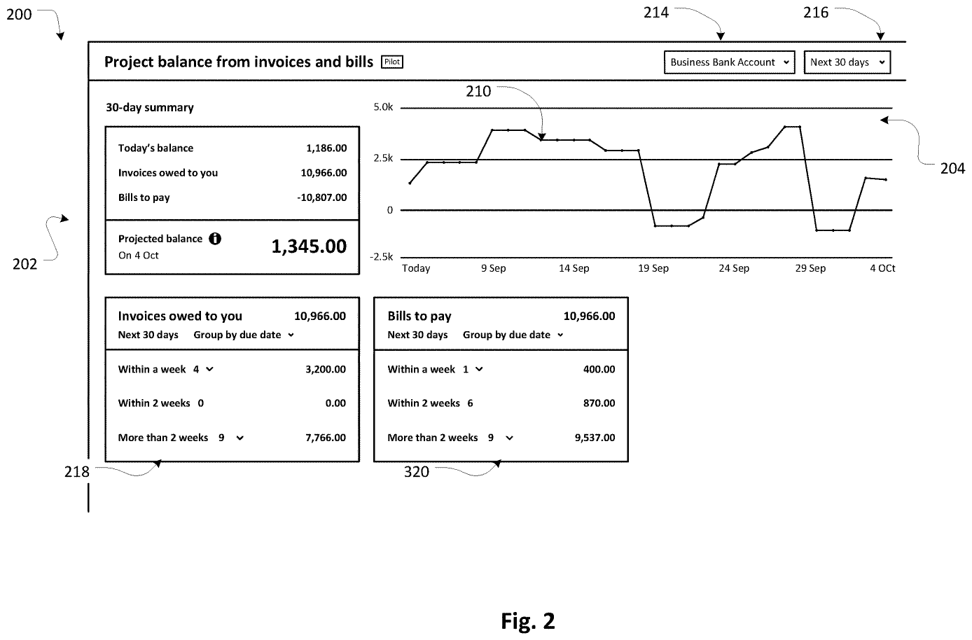

Described embodiments relate to methods, systems and computer program products for determining reoccurring transactions, which may be used to predict, for example. Some described embodiments relate to methods, systems and computer program products for determining model(s) for determining reoccurring transactions. In some embodiments, a capital management platform including a cash flow forecasting platform or tool is provided. The capital management platform is configured to determine predicted capital shortfalls and/or capital surpluses of an entity for a given period of time. The capital management platform may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example of such a graphical representation is presented in FIG. 2, and is discussed in more detail below.

The capital management platform may be configured to determine the predicted capital shortfalls and/or capital surpluses at a particular point or day in a given time period based on an assessment of financial data associated with the entity. Financial data associated with an entity may comprise banking data, such as banking data received via a feed from a financial institution, accounting data, payments data, assets related data, transaction data, transaction reconciliation data, bank transaction data, expense data, tax related transaction data, inventory data, invoicing data, payroll data, purchase order data, quote related data or any other accounting entry data for an entity. The financial data may comprise one or more financial records, which may be transaction records in some embodiments. Each financial record may comprise a transaction amount, a transaction date, one or more due dates and one or more entity identifiers identifying the entities associated with the transaction. For example, financial data relating to an invoice may comprise a transaction amount corresponding to the amount owed, a transaction date corresponding to the date on which the invoice was issued, one or more payment due dates and entity identifiers indicating the invoice issuing entity and the entity under the obligation to pay the invoice. Financial data may also comprise financial records indicating terms of payment and other conditions associated with the financial transaction associated with the financial data.

In some embodiments, the capital management platform may be configured to predict capital shortfalls and/or capital surpluses for a primary entity over a time period based on data relating to historical or current transaction data, or patterns of transaction data. In some embodiments, the capital management platform may be configured to identify recurring transactions in a database of transactions (for example, past transactions) and generate a model for predict future recurring transactions. In some embodiments, the model may then be used by the platform to predict recurring transactions for a given time period, which can then be used by the platform to determine or predict a baseline cash flow forecast.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

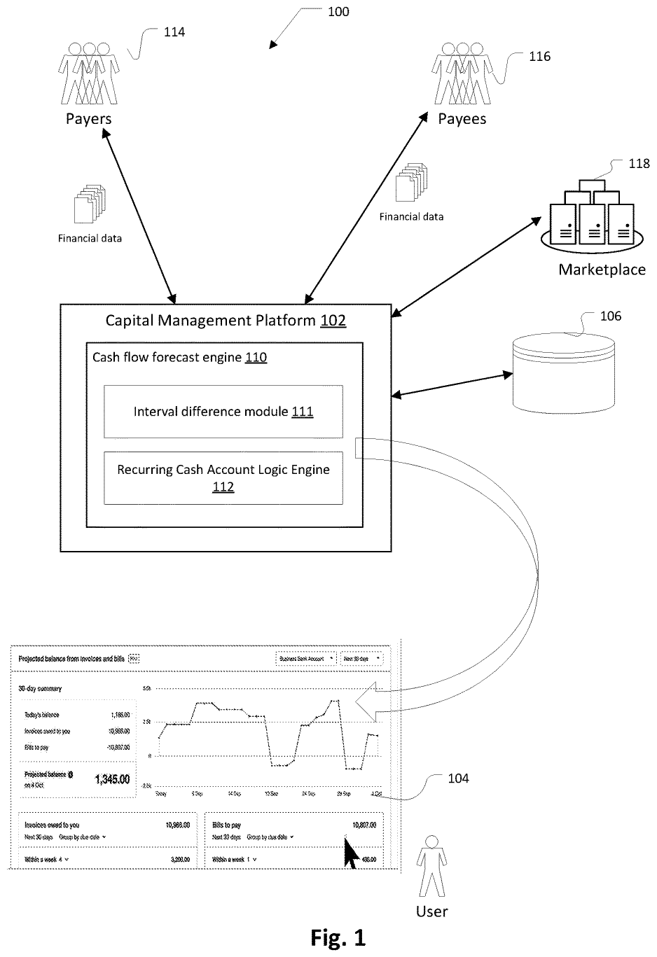

FIG. 1 illustrates a process 100 for using a capital management tool to improve capital management of an entity by forecasting future cash flow of the entity over a predetermined time period. In some embodiments, a capital management platform 102 may be provided to one or more client devices by one or more servers executing program code stored in memory. According to some embodiments, the capital management platform 102 may have the features and functions as described in PCT/AU2020/050924 and/or PCT/AU2020/051184, the entire contents of both of which are incorporated herein by reference. The capital management platform 102 may provide the cash flow forecast engine 110 for use by users of the one or more client devices. In some embodiments, the capital management platform 102 is arranged to communicate with a database 106 comprising financial information associated with a network of entities associated with the capital management platform 102, and may, for example, include accounting data for transactions between two or more entities. Accordingly, analysis of the data allows for inferences about the business interactions or transactions of those entities. For example, computational analysis of historical patterns of transactions between entities and trading behaviours of entities including responsiveness to financial obligations may be used to predict behaviours of the entities.

In some embodiments, database 106 may be part of an accounting system, such as a cloud based accounting system configured to enable entities to manage their accounting or transactional data. The accounting or transactional data may include data relating to bank account transactions or transfers, invoice data, billings data, expense claim data, historical cash flow data, quotes related data, sales data, purchase order data, receivables data, transaction reconciliation data, balance sheet data, profit and loss data, or payroll data, for example. Data in database 106 may enable identification of interrelationships between the primary entity and other entities based on the transactional data. The interrelationships may include relationships that define payment or debt obligations, for example. Based on the interrelationships between the primary entity and other entities, data in database 106 may be used to identify one or more networks of related entities that directly or indirectly transact with each other. Within a network of entities, the financial or cash flow position of one entity may have an impact on the financial or cash flow position of rest of the entities in the network.

The cash flow forecast engine 110 may comprise program code executable by one or more processors of the capital management platform 102. The cash flow forecast engine 110, when executed by the one or more processors of the capital management platform 102, may be configured to predict capital shortfalls and/or capital surpluses of an entity for a given period of time based on information derived from the database 106. For example, the cash flow forecast engine 110 may predict baseline capital shortfalls or baseline capital surpluses based on payment terms of transaction data, such as invoices.

The cash flow forecast engine 110 may comprise a recurring cash account logic engine 112 configured to analyse data relating to cash transactions, which may include petty cash transactions, to predict future cash transactions for the entity. Data relating to cash transactions includes data of payables or receivables in cash that an entity may engage in. The recurring cash account logic engine 112 may employ a predictive model such as a regression model or a trained neural network, for example, and may use historical data relating to cash transactions in order to predict future cash transactions that may be recurring during a given period.

The cash flow forecast engine 110 may be configured to determine a cash flow forecast based on outputs from the recurring cash account logic engine 112. In some embodiments, the cash flow forecast engine 110 may be configured to determine a baseline cash flow based on these outputs and, in some embodiments, to generate a graphical display for displaying the cash flow forecast to a user on a user interface of a client device.

In some embodiments, the cash flow forecast engine 110 may be configured to identify recurring transactions in a database of transactions (for example, past transactions) and generate a model for predicting future recurring transactions. Predicted recurring transactions for a given period may then be used by the cash flow forecast engine 110 in determining or predicting a baseline cash flow forecast.

The capital management platform 102 may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example screenshot of the visual display of the capital management platform 102 is shown in FIG. 2.

Referring now to FIG. 2, there is shown an example screenshot 200 of a visual display of the capital management platform 102. The screenshot 200 illustrates a graphical forecast or prediction relating to cash flow of a primary entity. This may include predictions relating to transactions, bills and/or invoices. Bills may comprise future payment obligations to one or more counterparties or related entities. Invoices may comprise future receivables from one or more counterparties or related entities. Section 202 provides an exemplary 30 day summary of a cash flow forecast for the primary entity, which may include forecasts for the entity's invoices and bills. Section 204 provides a graphical illustration of the cash flow forecast over the next 30 days for the entity. Points below the x-axis in the graph 204 indicate a negative total cash flow forecast at a particular point in time. Points above the x-axis indicate a positive cash flow forecast at a particular point in time. Section 204 comprises a baseline cash flow prediction line 210 indicating the cash flow position of the primary entity over the next 30 days.

Screenshot 200 also illustrates a selectable user input 214 allowing a user to select a particular account for which a cash flow prediction may be performed by the cash flow forecast engine 110. By selecting a different account from the selectable user input 214, a user may visualise a cash flow forecast for a different account for the entity. Screenshot 200 also illustrates another selectable user input 216 that allows a user to vary the duration over which the cash flow forecast engine 110 performs the cash flow prediction. A user may select a different duration of 60 days or 90 days, for example, to view a cash flow prediction over a different timescale.

Screenshot 200 also illustrates some financial data relating to invoices and bills which provides the basis for generation of the graphs in section 204. Section 218 illustrates a summary of financial data relating to invoices for the primary entity. In section 218, the financial data is summarised by the date on which an invoice is due. Section 220 illustrates a summary of financial data relating to bills for the primary entity. In section 220, the financial data is summarised by the date on which a bill is due.

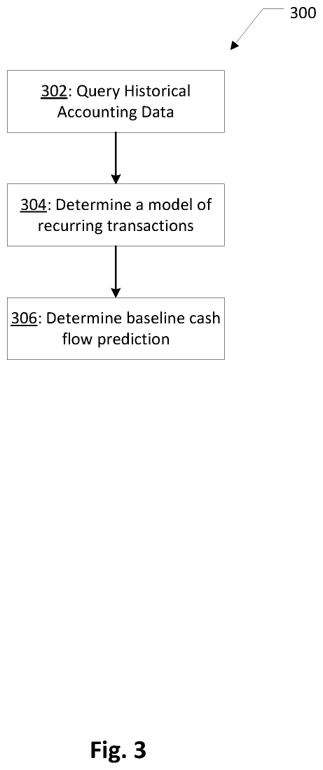

Referring now to FIG. 3, there is shown a process flow diagram illustrating a method 300 for forecasting cash flow for an entity, according to some embodiments. The cash flow forecast engine 110 may predict future cash flow of an entity based one of several techniques for predicting future cash flow based on past transactional data. The method of forecasting cash flow of FIG. 3 is an example of one of the methods of cash flow forecasting according to some embodiments. In some embodiments, one or more processors of the capital management platform 102 are configured to perform method 300.

At 302, the cash flow engine 110 determines financial or transactional data associated with a primary entity. For example, the cash flow engine 110 may query the database 106 to retrieve financial data, such as historical accounting data or transactional data relating to the primary entity. In some embodiments, the financial data is historical time series transactional data. Each record in the historical time series transactional data may comprise an amount and a date associated with the amount. In some embodiments, each record in the historical time series transactional data may comprise an amount, a date associated with the amount, and one or more other entities involved in the transaction. The historical data may provide a basis for determination of one or more models for prediction of future cash flow, such as models of recurring transactions. Once a cash flow prediction model is determined for a particular entity, the model may be varied over time as more data is made available to improve the accuracy of the cash flow prediction model. The transactional data may include data relating to one or more of: bank account transactions or transfers data, invoice data, billings data, expense claim data, cash flow data, quotes related data, sales data, purchase order data, receivables data, transaction reconciliation data, balance sheet data, profit and loss data, or payroll data, for example.

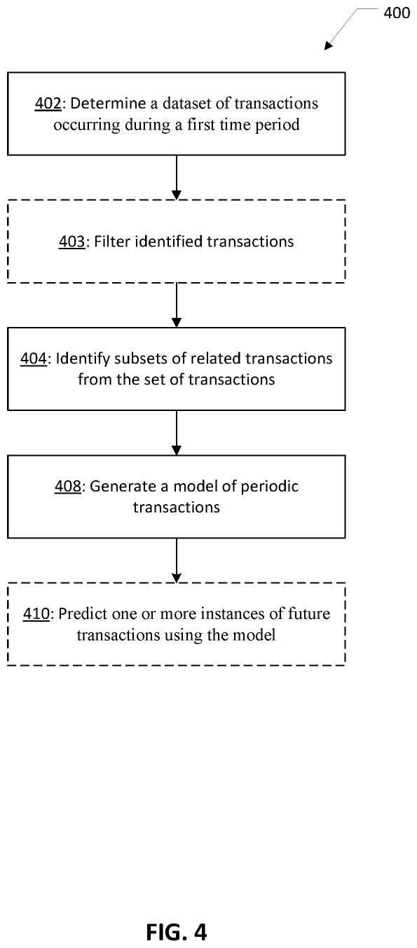

At 304, the cash flow engine 110 determines one or more models of recurring transactions. According to some embodiments, cash flow engine 110 may determine one or more models of recurring transactions by executing method 400 and/or method 500, as described in further detail below with reference to FIGS. 4 and/or 5, respectively.

At 306, based on the model determined at 304, cash flow forecast engine 110 determines future cash flow predictions. The steps 302 to 304 may be performed separately for different categories of historical transaction data records for an entity. For example, steps 302 to 304 may be separately performed for an entity's sales transaction data, expenses transaction data, payroll transaction data, for example. The historical transaction data may be appropriately characterised and sectored or categorised to individually model each sector or category. At step 306, the output of each model determined for an entity may be projected into the future to determine an overall future cash flow prediction for the entity.

Referring now to FIG. 4, there is shown a process flow for a method 400 of generating models identifying recurring transactions in a dataset of transactions. One or more models generated using method 400 may be used to predict one or more instances of future recurring transactions associated with a particular transaction attribute, such as an entity or particular account that is associated with the transaction. Accordingly, the step of determining a baseline cash flow prediction at 306 of method 300 may employ the model to predict recurring transactions and determine a baseline cash flow prediction. In some embodiments, the cash flow forecast engine 110, when executed by one or more processors of the capital management platform 102, is configured to perform method 400.

At step 402 of method 400, the cash flow forecast engine 110 determines and/or retrieves a dataset of transactions occurring during a first pre-determined time period. According to some embodiments, the pre-determined time period may be a period of time prior to the date on which method 400 is being performed. For example, the time period may be a duration of months prior to the date on which method 400 is being performed, such as a duration of 3 months. The dataset of transactions may be determined or obtained from database 106. Database 106 may comprise financial information associated with a network of entities associated with the capital management platform 102, and may, for example, include accounting data for transactions between two or more entities and one or more accounts associated with each of those entities. The transactions may be associated with one or more entities or contacts or may be associated with a network of entities. Each transaction is associated with corresponding transaction attribute information, such as date of the transaction, account name or type, account number, account name, contact name, contact identifier, payment or invoice amount, business registration number (such as ABN, NZBN, UK Companies House number, or the like), and/or contact address.

Optionally at step 403, the transactions identified at step 402 may be filtered using one or more filtering criteria. According to some embodiments, the criteria may be selected to remove transactions from the dataset that are less likely to relate to a set of recurring transactions. For example, in some embodiments, transactions that are less than a predetermined amount may be considered to be less likely to be recurring transactions, and therefore desirable to filter out of the dataset. A minimum transaction amount may therefore be selected as a filter amount. The minimum transaction amount may be $5, $20 or $50, for example. The minimum transaction amount may be selected to be likely to filter out non-recurring transactions while retaining recurring transactions.

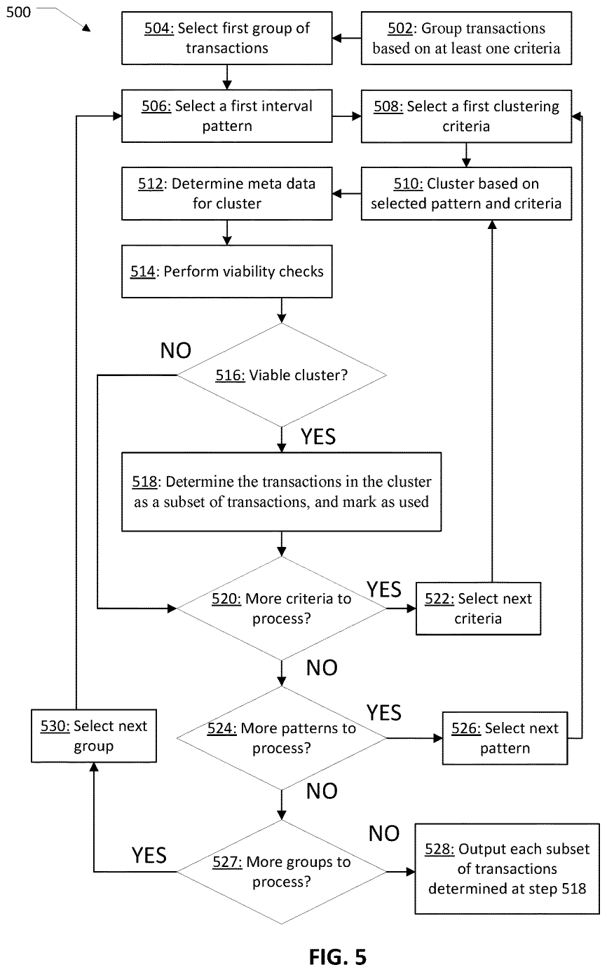

At step 404, the cash flow forecast engine 110 attempts to identify one or more subsets of related transactions from the dataset of transactions that may relate to one or more recurring transactions. The related transactions may be any transactions that have similar or substantially corresponding values for one or more of the attributes of the transactions. In some embodiments, each subset of related transactions is determined by identifying a group of transactions that have one or more common attributes. For example, the common attributes may include one or more of a common transacting entity; a common bank account name, number or type; a common transaction amount; a common contact name or contact identifier such as business registration number (such as ABN, NZBN, UK Companies House number, or the like), and/or contact address. According to some embodiments, cash flow forecast engine 110 determines subsets of related transactions that may relate to recurring transactions by executing method 500, as described in further detail below with reference to FIG. 5. In some embodiments, no suitable subsets may be identified, in which case method 400 may terminate.

Where suitable subsets of transactions are identified at step 404, then at step 408, the cash flow forecast engine 110 generates a model of periodic transactions based on the identified subset(s) of related transactions and the interval for each of the subset(s). The model includes, for each of the subset(s), the interval and at least one of the common attributes common to each of the related transactions. At optional step 410, the cash flow forecast engine 110 then uses the model to predict one or more instances of future recurring transactions which may, for example, be associated with a particular entity or particular account of an entity. The predicted recurring transactions may then be used to determine the baseline cash flow prediction of method 300 at step 306, as described above. For example, the model may be associated with particular recurring transactions and be indicative of one or more attributes of the transaction: (i) payment amount; (ii) regularity of payment; (iii) day(s), week(s), month(s), and/or year(s) on which payment is predicted to be paid; (iv) account to and/or from which payment is predicted to be made; and (v) contact to and/or from which payment is predicted to be made.

The performance of method 400 can be measured or assessed using metrics such as coverage and precision. These metrics may be determined by counting the number of predicted transactions and actual future transactions over a predetermined time window. For example, according to some embodiments, the number of transactions predicted to occur one month after the date the predictions are generated may be counted, and the number of actual transactions that occur in the same time period, being one month after the date the predictions are generated, are also counted.

The coverage refers to the proportion of predictions made correctly for each organisation to the number of actual future transactions of that organisation, and may be calculated by dividing the number of correct predictions by the total number of future transactions for the organisation. For example, an organisation may have 100 transactions in the future (as at the date the predictions are being generated). Performing method 400 may cause 80 future transactions to be predicted. Of these, 60 may be correct, while 20 may be incorrect. The coverage may be determined by dividing the number of correctly predicted transactions (60 in this example) by the number of actual future transactions (100 in this example), which may give a coverage of 0.6 in this example.

The precision refers to the proportion of correctly predicted transactions for an organisation to the total number of predicted transactions for that organisation, and may be calculated by dividing the number of correctly predicted transactions by the total number of predicted transactions for the organisation. For the above example, the coverage may be determined by dividing the number of correctly predicted transactions (60 in the above example) by the total number of predicted transactions (80 in this example), which may give a coverage of 0.75 in this example.

Where no predictions are made for an organisation, the prediction may be undefined, as the denominator of the calculation is zero. If an organisation doesn't have any transactions, the coverage may be undefined, as the denominator of the calculation is zero.

An experiment was conducted by performing method 400 on a dataset containing transactions randomly sampled from 100,000 organisations. The coverage and precision of the predicted results was determined, and are provided below in Table I.

TABLE I

| Metric | Metric Value |
|---|---|
| Precision mean | 0.4214 |
| Precision median | 0.4286 |
| Precision undefined | 30.241 |
| Coverage mean | 0.1078 |
| Coverage median | 0.0309 |
| Coverage undefined | 4929 |

FIG. 5 is a process flow diagram of a method for determining at least one subset of related transactions from a dataset of transactions, and which may be used at 404 of method 400. The cash flow forecast engine 110, when executed by one or more processors of the capital management platform 102, may be configured to perform method 500.

At step 502, the cash flow forecast engine 110 receives the group of transactions from the dataset of transactions identified at step 402 and/or 403 of method 400, and groups the transactions based on at least one grouping criteria. According to some embodiments, the grouping criteria may include one or more attributes shared among the transactions to be grouped. For example, the common attributes may include one or more of a common transacting entity; a common bank account name, number or type; a common transaction amount; a common contact name or contact identifier such as business registration number (such as ABN, NZBN, UK Companies House number, or the like), and/or contact address. In some embodiments, the group or groups of transactions are each associated with a respective period of time within which the transaction occurred.

In some embodiments, such as where the transactions weren't already filtered during method 400, the received transactions in the one or more groups may be filtered using one or more filtering criteria. According to some embodiments, the criteria may be selected to remove transactions from the dataset that are less likely to significantly impact the cash flow of an organisation. According to some embodiments, the criteria may be selected to remove transactions from the dataset that are less likely to relate to a set of recurring transactions. For example, in some embodiments, transactions that are less than a predetermined amount may be considered to be less likely to have an effect on cash flow, and therefore desirable to filter out of the dataset. A minimum transaction amount may therefore be selected as a filter amount. The minimum transaction amount may be $5, $20 or $50, for example. In some embodiments, transactions that are less than a predetermined amount may be considered to be less likely to be recurring transactions, and therefore desirable to filter out of the dataset. The minimum transaction amount may be selected to be likely to filter out non-recurring transactions while retaining recurring transactions.

According to some embodiments, the grouped transactions may optionally be sorted into a predetermined order within each group. For example, the transactions may be sorted by transaction date. In some embodiments, the transactions may be sorted by transaction date in descending order, such that the most recent transactions appear first in the dataset in each group. This may assist in the performance of the clustering process described below by ensuring the algorithm is looking at the most recent transactions first, which may be more likely to be relevant. In some embodiments, multiple transactions may occur on any one or more days. In other words, one or more transactions may be associated with a given transaction date.

At step 504, cash flow forecast engine 110 selects a first group of transactions from the groups identified at step 502.

At step 506, the cash flow forecast engine 110 selects a first interval pattern for the purpose of identifying possible recurring transactions. The interval pattern may be any interval of time on which a transaction may recur. For example, the interval pattern may be a week, fortnight, month, quarter, or year, in some embodiments. According to some embodiments, cash flow forecast engine 110 may have access to a stored list of interval patterns, and may select the shortest of these interval patterns as a first interval pattern. For example, where the list of interval patterns comprises the intervals of a week, fortnight or month, cash flow forecast engine 110 may select a week as the first interval pattern.

At step 508, the cash flow forecast engine 110 selects at least one first clustering criteria. Clustering criteria may include any criteria that may help to identify whether a group of transactions are recurring transactions. For example, clustering criteria may include one or more of a deviation from a transaction interval based on the selected interval pattern, a difference in transaction amount, and a minimum number of transactions in a pattern, for example. A large set of transactions that do not deviate from a determined transaction interval and that all have a similar transaction amount are more likely to relate to a recurring transaction. Transactions that significantly deviate from a transaction interval, that significantly differ in payment amount and/or that only comprise a small set of transactions are less likely to be useful in building a model of recurring transactions.

According to some embodiments, cash flow forecast engine 110 may select at least one first clustering criteria from a stored list of clustering criteria, which may be ordered from strictest to most lenient. A strict criteria may be defined as a criteria that selects fewer transactions, while a more lenient criteria may be a criteria that selects a larger group of transactions. A clustering criterion may be a threshold transaction interval deviation, for example, a threshold number of days the transaction date of a transaction deviates from the weekly interval pattern. For example, where a weekly interval pattern has been selected, a transaction interval deviation of zero would be a strict clustering criteria, while a transaction interval deviation of three might be a lenient clustering criteria. An allowed difference in payment amount of 1% may be a strict clustering criteria, while an allowed difference in payment amount of 20% may be a lenient clustering criteria. Cash flow forecast engine 110 may select one or more of the strictest clustering criteria as a first clustering criteria.

At step 510, based on the interval pattern selected at step 506 and the clustering criteria selected at step 508, the cash flow forecast engine 110 creates a cluster of transactions that meet the criteria from the group of transactions selected at step 504. For example, if the interval pattern was weekly, and the clustering criteria was a deviation from the transaction interval of one, a difference in transaction amount of 10%, and a minimum transactions number of 10, cash flow forecast engine 110 may be configured to create a cluster where the transactions in the cluster have a transaction date separated by an interval of between 6 and 8 days, that differ in transaction amount by a maximum of 10%, and that contain at least 10 transactions.

To determine which transactions in the group of transactions selected at step 504 meet the criteria for the interval pattern, the cash flow forecast engine 110 may first calculate an interval difference between at least one pair of transactions in the subset or group of transactions selected at step 504. In some embodiments, cash flow forecast engine 110 may calculate an interval difference between each of the transactions in the subset or group of transactions selected at step 504. The cash flow forecast engine 110 may then determine whether each calculated interval difference is within the allowable deviation from the selected transaction interval.

In some embodiments, the cash flow forecast engine 110 may comprise an interval difference module 111 or component configured to determine the interval difference or transaction interval deviation between dates of pairs of transactions. The interval difference module may be configured to receive the respective dates of a pair of transactions and to provide as an output, an interval difference or transaction interval deviation between the dates. The interval difference or transaction interval deviation may be a value, such as a number of days.

According to some embodiments, the interval difference may be calculated using at least the month and date of the transaction date of each selected transaction, and calculating the difference between the transactions dates. The difference may be expressed as a number of days. For example, where there are three selected transactions with transaction dates of 10 Nov. 2022, 10 Dec. 2022, and 10 Jan. 2023, the cash flow forecast engine 110 may determine that the interval differences are 30 and 31 days, respectively.

In some cases, a recurring transaction may be expected to fall on a weekend, or on a public holiday falling on either side of the weekend. For example, this may be the case where the interval pattern or cadence is months (e.g. ‘occurs monthly on the x^{th} of the month’), and the date for one or more months falls on a Saturday or a Sunday, i.e. the weekend, and not on a business day (Monday to Friday). Such transactions may actually occur earlier or later than expected transaction date, that is on a business day and not on the weekend. This may be because fewer users transact on weekends. For example, the transaction may be brought forward to the Friday, a day or two before the expected transaction date, or may be pushed back to the Monday, a day or two after the expected transaction date.

In some embodiments, to account for such situations, the transaction interval deviation (or maximum transaction interval deviation) may be set to two (which may account for weekends) or three (which may account for a public holiday on a Monday or Friday, in addition to weekends). Accordingly, if the expected transaction date fell on Sunday 16 April, but actually occurred earlier on Friday 14 April, the transaction interval deviation would be determined as being two days, and the transaction would meet the transaction interval deviation criterion of the clustering criteria. However, setting the transaction interval deviation criterion at two or three to account for transactions potentially occurring on weekends or public holidays may be considered too relaxed or lenient, and may result in irrelevant transaction(s) being classified as recurring transactions, i.e. false positives.

In other embodiments, only business days (i.e. Monday to Friday) are counted or considered as contributing to the transaction interval deviation between two dates; non-business days/weekend days are ignored, or counted as zero. In some embodiments, only business days are considered in determining transaction interval deviations where the interval pattern is “monthly”, “fortnightly”, “weekly”, “quarterly”, “half-yearly” or “annually”, for example. The cash flow forecast engine 110 may determine a transaction interval deviation of a first and second date based on values for the first date and the second date. The cash flow forecast engine 110 may determine a transaction interval deviation between a first date and a second date as the first date minus the second date, less a number of weekend days falling between the first date and second date. The cash flow forecast engine 110 may determine a number of business days occurring between a first date and a second date as the transaction interval deviation. For example, the cash flow forecast engine 110 may determine business days and/or weekend days falling within a specific period of time associated with the group(s) of transactions and/or falling between (and inclusive of) the first date and the second date.

In this way, regardless of whether the expected transaction falls on a Saturday or Sunday but actually occurs on a Friday or Monday, identification or determination of the interval pattern is not impacted or is at least less impacted than otherwise may be the case.

For example, the cash flow forecast engine 110 may be configured to determine the following transaction interval deviations for the respective first and second dates, as shown in Table II:

TABLE II

| | | Transaction |
|---|---|---|
| First date | Second date | interval deviation |
| Wed, 1 Feb. | Thurs, 2 Feb. | One |
| Wed, 1 Feb. | Fri, 3 Feb. | Two |
| Wed, 1 Feb. | Sat, 4 Feb. | Two |
| Wed, 1 Feb. | Sun, 5 Feb. | Two |
| Wed, 1 Feb. | Mon, 6 Feb. | Three |
| Wed, 1 Feb. | Tues, 31 Jan. | One |
| Wed, 1 Feb. | Mon, 30 Jan. | Two |
| Wed, 1 Feb. | Sun, 29 Jan. | Two |
| Wed, 1 Feb. | Sat, 28 Jan. | Two |
| Wed, 1 Feb. | Fri, 27 Jan. | Three |

Accordingly, the transaction interval deviation criterion may be set more stringently, and may for example, be set at zero or one. This would mitigate the chance of false positive transactions being classified as recurring transactions, while still accounting for the possibility of recurring transactions having expected dates that fall over the weekend (or on single day public holidays where the transaction interval deviation criterion is set at one) actually occurring on the Friday or Monday instead.

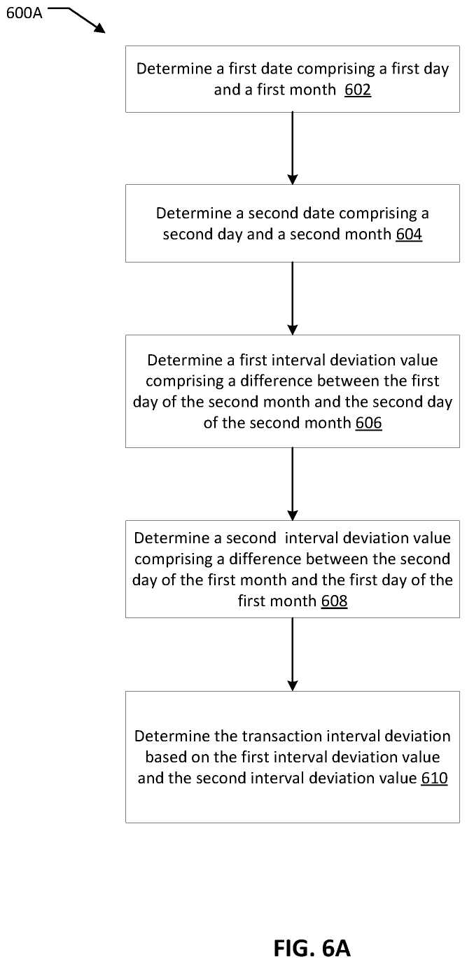

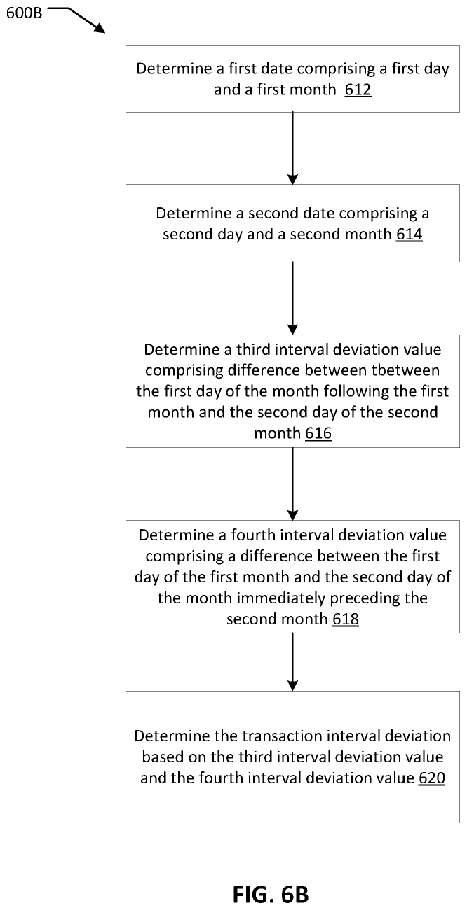

An example of a process flow diagram of a method 600A for determining a first interval difference or transaction interval deviations between dates of pairs of transactions, and which may be used at 510 of method 500, is shown in FIG. 6A. The cash flow forecast engine 110 (or interval difference module 111), when executed by one or more processors of the capital management platform 102, or similar system, may be configured to perform method 600A.

As illustrated in FIG. 6A, the cash flow forecast engine 110 determines 602 a first date comprising a first day and a first month, and determines 604 a second date comprising a second day and a second month. The cash flow forecast engine 110 determines a transaction interval deviation based on the first date and the second date. In some embodiments, the cash flow forecast engine 110 may determine the transaction interval deviation based on business days only, discounting or ignoring weekend days from the count.

For example, in some embodiments, as depicted in FIG. 6A, the cash flow forecast engine 110 may be configured to determine 606 a first interval deviation value comprising a difference (for example, the number of days, or in some embodiments, business days) between the first day of the second month and the second day of the second month. The cash flow forecast engine 110 may be configured to determine 608 a second interval deviation value comprising a difference (for example, the number of days, or in some embodiments, business days) between the second day of the first month and the first day of the first month.

In some embodiments, the cash flow forecast engine 110 may be configured to check or determine whether the first day of the second month and/or the second day of the first month are valid dates. For example, where the first date is 31 March and the second date is 1 April, the first day of the second month would be 31 April, which is an invalid date (April having only 30 days). Accordingly, in some embodiments, in response to the cash flow forecast engine 110 determining that the first day of the second month or the second day of the first month is not a valid date, modifying or changing the invalid date to the closest date in the same month. For example, in the above example, the 31 April would be changed to 30 April.

The cash flow forecast engine 110 determines 610 the first interval difference based on the first interval deviation value and the second interval deviation value. In some embodiments, the cash flow forecast engine 110 may determine the first interval difference as the minimum of the first interval deviation value and the second interval deviation value.

By effectively projecting the day of the first date onto the month of the second date and vice versa as discussed, the possibility that the first month and the second month are not the same month and may have different numbers of days is accounted for or accommodated, and any impact that might have on the determination of the first transaction interval deviation mitigated or negated.

An example of a process flow diagram of a method 600B for determining a second interval difference or transaction interval deviations between dates of pairs of transactions, and which may be used at 510 of method 500, is shown in FIG. 6B. The cash flow forecast engine 110 (or interval difference module 111), when executed by one or more processors of the capital management platform 102, or similar system, may be configured to perform method 600B. The method 600B may be used as an alternative to method 600A or may be used in addition to 600A. Where method 600A and 600B are combined, the cash flow forecast engine 110 may determine an interval difference (for example, an overall interval difference) based on the first interval difference and the second interval difference. For example, in some embodiments, the interval difference may be considered to be the minimum of the first interval difference and the second interval difference.

As illustrated in FIG. 6B, the cash flow forecast engine 110 determines 612 a first date comprising a first day and a first month, and determines 614 a second date comprising a second day and a second month.

At 616, the cash flow forecast engine 110 determines a third interval deviation value as a difference (for example, the number of days, or in some embodiments, business days) between the first day of the month following the first month and the second day of the second month. For example, if the first date is 1 April and the second date is 31 April, the first day of the month following the first month is 1 May.

At 618, the cash flow forecast engine 110 determines a fourth interval deviation value as a difference (for example, the number of days, or in some embodiments, business days) between the first day of the first month and the second day of the month immediately preceding the second month. For example, if the first date is 1 April and the second date is 31 April, the second day the month immediately preceding the second month is 31 March.

At 620, the cash flow forecast engine 110 determines the second interval difference based on the third interval deviation value and the fourth interval deviation value. In some embodiments, the cash flow forecast engine 110 determines the second interval difference as the minimum of the third interval deviation value and the fourth interval deviation value.

In this way, the cyclical nature of the calendar is accounted for or accommodated when calculating the interval differences. For example, although the dates of the month on which some transactions occur, such as 1 April and 31^{st} March are not numerically close to one another (being 1 and 30), the cash flow forecast engine 110 can still accurately capture the real interval differences between the dates.

An experiment was conducted on a dataset containing transactions randomly sampled from 99,220+ organisations. The experiment involved performing method 500 to determining a model for predicting weekly recurring transactions, including methods 600A and 600B, and wherein the weekend days were discounted from contributing to the interval difference, as discussed above. The results achieved are shown below in Table III. As only business days are counted, the interval threshold was set at “one”. For comparison, the results achieved by performing method 500 without accounting for weekends and without performing methods 600A and 600B are shown in Table IV. As both business and weekend days are counted, the interval threshold was set at “three”.

TABLE III

| Metric | Metric Value |
|---|---|
| Coverage mean | 0.0966 |
| Coverage median | 0.0000 |
| Coverage undefined | 700 |
| Precision mean | 0.2913 |
| Precision median | 0.2222 |
| Precision undefined | 29869 |
| Org count | 99234 |

TABLE IV

| Metric | Metric Value |
|---|---|
| Coverage mean | 0.0981 |
| Coverage median | 0.0000 |
| Coverage undefined | 700 |
| Precision mean | 0.2846 |
| Precision median | 0.2140 |
| Precision undefined | 28786 |
| Org count | 99234 |

As shown by a comparison of Table III and Table IV, by performing method 500 including methods 600A and 600B, and discounting weekend days from contributing to the interval difference, resulted in a model with improved precision. While it is acknowledged that the coverage results of Table III are lower than those of Table IV, this difference can be considered effectively negligible given that the interval threshold was set at “one” (Table III) compared with an interval threshold of “three” (Table IV).

In some embodiments, the cash flow forecast engine 110 may use just the day of the week or day or date of the month to calculate the interval difference between two transaction dates. This may reduce the computational power required to determine each of the interval differences, and may reduce the effect of missing transactions and differences in the lengths of different months on the interval calculations.

For example, where the selected interval pattern is a monthly interval pattern, the cash flow forecast engine 110 may use only the day of the month to determine the interval difference, by determining a difference in the day of the month on which each pair of transactions took place. Where there are three selected transactions with transaction dates of 10 Nov. 2022, 10 Dec. 2022, and 10 Jan. 2023, the cash flow forecast engine 110 may simply use the date of the month on which each transaction was performed, being the 10^{th} in each case for this example. Cash flow forecast engine 110 may determine the difference between the dates of the month, and see whether the interval difference is within the allowable deviation from the selected transaction interval. In the above example, as all of the transactions fall on the same date of the month, cash flow forecast engine would determine the deviation from the monthly transaction interval to be 0. Cash flow forecast engine 110 may therefore determine that the transactions follow a monthly interval pattern. This may produce a more accurate result than calculating the actual number of days between each transaction as described above, as this method does not need to take into account the number of days in each month, which would otherwise affect the calculation of the interval difference.

Where the selected interval pattern is a weekly or fortnightly pattern, the cash flow forecast engine 110 may use only the day of the week to determine the interval difference, by determining a difference in the day of the week on which each pair of transactions took place.

Cash flow forecast engine 110 may take the cyclical nature of the calendar into account when calculating the interval differences. For example, while the 1^{st} and the 30^{th} may be considered 29 days apart when looking at the date of the month on which a transaction occurred, due to the cyclical nature of dates flowing into a new month cash flow forecast engine 110 may consider these dates to be close together to one another. For example, where there are three selected transactions with transaction dates of 30 Nov. 2022, 1 Jan. 2022, and 31 Jan. 2023, cash flow forecast engine 110 may determine that these transactions have a monthly interval pattern, although the dates of the month on which these transactions occur are not numerically close to one another (being the 30^{th}, 1^{st} and 31^{st}).

In order to achieve this, cash flow forecast engine 110 may calculate the shortest distance between two days or dates where the days are mapped to a circle or considered to wrap, such that the day with the highest value is considered to be adjacent to the day with the lowest value. For example, when the interval pattern is weekly, the days of the week may be given the values of 1, 2, 3, 4, 5, 6 and 7, and mapped such that 7 is considered to be adjacent to 1. In this manner, when determining the distance between day 1 and day 3, the shortest distance would be 2, as it takes two steps to get from 1 to 3. If the numbers from 1 to 7 were mapped to a circle in a clockwise manner, it would take two steps moving clockwise to get from 1 to 3. When determining the distance between day 1 and day 7, the shortest distance would be 1, as it takes one step to get from 1 to 7. If the numbers from 1 to 7 were mapped to a circle in a clockwise manner, it would take one step moving anti-clockwise to get from 1 to 7.

In some alternative embodiments, cash flow forecasting engine 110 may map the determined dates of the month to a trigonometric function such as sine or cosine before comparing the dates to determine the transaction interval. Cash flow forecasting engine 110 may then determine a difference in the trigonometric value corresponding to the dates on which the pair of transactions took place. While the numerical difference between the first and last day of a month such as the 1st and 31st is 30 days, mapping this to a trigonometric function would result in the difference of these dates being 1. Having determined a cluster of transactions, at step 512 cash flow forecast engine 110 determines at least one attribute or meta data value relating to the cluster (e.g., the cluster attribute). According to some embodiments, the attribute may include one or more of: the date of the last transaction in the cluster; an individual transaction interval value for each transaction in the cluster; an interval value relating to the cluster; and the number of transactions in the cluster.

According to some embodiments, the attribute (or cluster attribute) may include one or more interval values relating to the subset of transactions. Each interval may be indicative of a periodicity of the subset. The distribution of individual transactions in a subset may be regular or irregular. A single individual transaction may occur on the 15th day of every month, in which case the distribution of individual transactions in the subset would be regular and the interval of the subset would be monthly. Multiple individual transactions may occur regularly, for example, on particular days of the week, such as every Monday and Friday, in which case the distribution of individual transactions in the subset would be irregular and the interval of the subset would be weekly. Similarly, multiple payments may occur on different days of a month, for example, the 3rd, 5th, 27th and 29th of the month, and these transactions may occur every month. Accordingly, the distribution of the individual transactions within the subset is irregular, and the interval of the subset itself is monthly.

In some embodiments, individual transaction intervals of related transactions of the subset, that is the time period (e.g. day(s)) between a first related transaction and a next occurring/occurred related transaction, are determined. The interval of the subset may then be determined as being the median of the individual transactions intervals of the related transactions. In other embodiments, a distribution of the individual transactions intervals of the related transactions is compared with one or more template or model distributions, each associated with a periodic distribution, such as weekly, monthly etc. The interval of the subset(s) may be determined based on the template or model distributions to which the distribution of the individual transactions intervals most closely matches.

In some embodiments, a binned median interval may be calculated for the cluster. Individual transaction intervals may be placed into bins defining ranges of intervals. This may be done by first calculating individual transaction intervals as described above. The individual transaction intervals may then be rounded to the nearest multiple of the expected interval based on the interval selected as the interval patterns at step 506. For example, where a “weekly” interval pattern was selected, and the individual transaction intervals were calculated as being [7, 6, 6, 14, 14, 8], these would be rounded to [7, 7, 7, 14, 14, 7]. The number of occurrences of each interval in the list is then counted. In this case, the interval ‘7’ appears 4 times, and the interval ‘14’ appears 2 times. The interval with the highest count may then be used to determine the actual interval of the subset. In this example, as ‘7’ has the highest count, the interval of the subset may be determined to be ‘weekly’.

In some alternative examples, rather than rounding the individual intervals, bins of interval ranges may be created, and the individual intervals may be placed in the bins before counting. In the above example, bins of 0-3 days, 4-10 days, and 11-17 days may be defined. Each interval may be placed into a corresponding bin, and the bin with the highest number of intervals may be used to determine the most common interval in the subset. In the above example, the intervals [7, 6, 6, 8] would be placed in the 4-10 day bin, while the intervals [14, 14] would be placed in the 11-17 day bin. The centroid value of the defined bin (i.e. 7 for 4-10 and 14 for 11-17) having the highest count might then be used to determine the interval of the subset.

In some embodiments, suitable template distributions may be selected based on a type of account, or the account name, relating to the transactions being assessed. For example, if the account name is Payroll, and employees are generally paid on the last Thursday of the month, a template of a monthly distribution may be used to determine or identify the interval and/or a sufficient regularity of the occurrence of the related transactions. In other embodiments, an assessment of historical payments from a particular account name to a particular contact or contact type may be assessed to determine a pattern of regular payments, and may be used to generate a distribution model for use in assessing the regularity of related transactions for particular account names and/or contacts.

At step 514, the cash flow forecast engine 110 may perform one or more viability checks on the identified cluster. The viability checks may be used to determine whether the transactions in the identified cluster are likely to be examples of transactions forming a recurring transaction pattern with the interval selected at step 506. According to some embodiments, the viability checks may include checking one or more of: the recency of the latest transaction in the cluster; the extent to which the intervals of the cluster match a determined pattern; and the number of unique transactions in the cluster.

Checking the recency of the latest transaction in the cluster may comprise determining the difference between the date of the last transaction in the cluster as determined in step 512 and the current date, and determining if the difference is less than a predetermined threshold. For example, a cluster may be determined unviable if the latest transaction in the cluster is determined to have occurred more than a month, three months, six months or a year before the date of processing. According to some embodiments, the threshold may be determined based on the interval pattern selected at step 506. For example, where the selected interval pattern is ‘weekly’ the threshold may be lower than when the selected interval pattern is ‘monthly’.

Checking the extent to which the intervals of the cluster match a determined pattern may include checking whether the transactions fit the pattern selected at 506. As transactions may fit into more than one pattern, cash flow forecast engine 110 may use the intervals for the cluster calculated at step 512 to determine whether the transactions in the selected cluster do fit the selected pattern. For example, cash flow forecast engine 110 may compare the interval defined by the selected interval pattern as selected at step 506 with the median or binned median interval pattern calculated at step 512. Where the calculated interval for the cluster does not match the interval defined by the selected pattern, the cluster is determined to be unviable. This may occur where the selected pattern is a “fortnightly” interval pattern, but the clustered transactions actually form a weekly interval pattern, for example.

Checking the number of unique transactions in the cluster may comprise comparing the number of transactions in the cluster with a predetermined threshold. The cluster may be deemed to be unviable if the number of transactions in the cluster is less than a predetermined threshold. According to some embodiments, the threshold may be 5, 10 or 15 transactions, for example.

According to some embodiments, the viability checks may also include an interval check based on the individual transaction intervals of related transactions that may have been calculated at step 512. According to some embodiments, the interval check may comprise determining whether any of the individual transaction intervals are zero, indicating multiple transactions that occurred on the same day. As having multiple transactions on a given day means that more than one transaction could fit in a particular position in a pattern of recurring transactions, where at least one such transaction interval is identified the cash flow forecast engine 110 may consider the cluster unviable. According to some embodiments, the cash flow forecast engine 110 may consider the cluster unviable if more than a threshold amount of individual transaction intervals are zero. For example, cash flow forecast engine 110 may consider the cluster unviable if more than half of the individual transaction intervals in the subset are zero.

In other embodiments, the determined dataset of transactions, or the subset of related transactions determined from the dataset of transactions are filtered to include only a single transaction per day or date. In some embodiments, the determined dataset of transactions, or the subset of related transactions determined from the dataset of transactions are filtered to remove all transactions that have a transaction date in common with or the same as another transaction. In other words, where multiple transactions occurred on a same day, all of those transactions are removed from the determined dataset of transactions, or the subset of related transactions determined from the dataset of transactions.

According to some embodiments, in order to allow for drift in transaction dates within a pattern, the cash flow forecast engine 110 executing step 514 may first round each individual transactions interval to the nearest multiple of the identified pattern length. For example, where the pattern length is 7 days or one week, the individual transactions intervals may be rounded to the nearest multiple of seven, such that the set of intervals [1, 5, 0, 12, 9] would be rounded to [0, 7, 0, 14, 7]. This avoids mere drift in transaction dates causing subsets of transactions to pass the interval check.

In some embodiments, multiple transactions of the same or similar amounts may occur on the same day. Such multiple transactions on a single day may collectively relate to a single reoccurring transaction, for example, a $300 transaction recurring every week but split into three invoices of $100. Alternatively, such multiple transactions on a single day may relate to two separate reoccurring transactions, such as two separate $100 transactions recurring every week, or a first $100 transaction recurring every week and a second $100 transaction recurring every fortnight. Where multiple transactions are determined on a given day, the respective individual transaction intervals are deemed to be zero. In such cases, more than one of the multiple transactions on the given day may fit in a particular position in a pattern of recurring transactions.

Similarly, multiple transactions of a particular and same cadence may occur, with for example similar or same amounts. For example, consider the example of four transactions occurring in time sequence: Tx1, Tx2, Tx3, and Tx4. If Tx1 and Tx2 occur on the same day, the individual transaction interval between Tx1 and Tx2 will be ‘0’. If the Tx3 occurs a week after Tx2, then the individual transaction interval between Tx2 and Tx3 may be deemed to be ‘7’, and if Tx4 occurs on the same day as Tx3, the individual transaction interval between Tx3 and Tx4 will be ‘0’. Thus, the set of individual transactions intervals may be determined to be (0,7,0). In such embodiments, multiple subsets of individual transactions intervals may be determined from the set individual transactions intervals, with each subset potentially representing a different reoccurring transaction. For example, a first cluster may comprise Tx1 and Tx3 with a first individual transaction interval set (7) and a second cluster Tx2 and Tx4 a second individual transaction interval set (7). The transactions associated with each subset may also be considered as to whether they comply with a specific interval pattern, and clustering criteria, such as difference in transaction amounts. The transactions of such compliant interval difference subsets may then be determined as clusters of transactions for use in determining model of recurring transactions. In this way, multiple transactions occurring on a same day but relating to different interval patterns do not preclude a cluster from being considered as a viable cluster, do not negatively impact the matching the cluster to a determined interval pattern and/or do not negatively impact the ability to correctly identify reoccurring patterns of transactions.

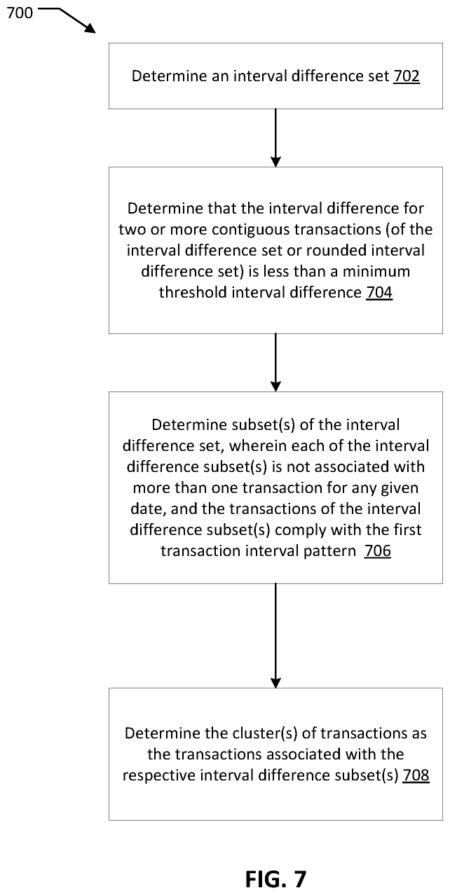

An example of a process flow diagram of a method 700 for determining one or more clusters of transactions, and which may be used at 510 of method 500, is shown in FIG. 7. The cash flow forecast engine 110, when executed by one or more processors of the capital management platform 102, or similar system, may be configured to perform method 700.

At 702, cash flow forecast engine 110 may determine an interval difference set. The interval difference set may comprise an interval difference between the dates of at least a plurality of pairs of transactions in the subset of related transactions (e.g, Tx1, Tx2, Tx3, Tx4, and Tx5). For example, the interval difference set may be [1, 8, 1, 6]. For example, the interval difference set may be [0, 7, 0, 7], which may be one wherein the individual transactions intervals are rounded to the base value (in this case, 7). In other words, the cash flow forecast engine 110 may determine a rounded interval difference set wherein the individual transactions intervals are rounded to the base value.

At 704, the cash flow forecast engine 110 determines that the interval difference for at least two or more contiguous transactions (of the interval difference set or rounded interval difference set) is less than a minimum threshold interval difference. This would mean that the transactions would be considered as potentially or actually having occurred on the same transaction date. Transactions occurring on the same transaction date may be considered to potentially belong to different reoccurring transactions.

The minimum threshold interval difference may be set at ‘one’, for example, in which case, only contiguous transactions that occurred on the same date would be identified as having interval differences that don't meet the minimum threshold interval difference. In some embodiments, the minimum threshold interval difference may be set at ‘two’ or ‘three’, which may, in some embodiments, accommodate transactions expected to occur on a date falling over the weekend or on public holidays, but which instead occur the day before or after the weekend and/or public holiday, as discussed above. In other embodiments, also discussed above, only business days (that is not weekend days) are considered to contribute to the interval difference value.

At 706, the cash flow forecast engine 110 determines one or more interval difference subsets of the interval difference set. Each of the interval difference subset(s) is not associated with more than one transaction for any given transaction date. So, for example, where the interval difference set include a zero value interval difference, the cash flow forecast engine 110 may determine two interval difference subsets. The transactions of the interval difference subset(s) comply with the first transaction interval pattern. So for example, where the first transaction interval pattern is weekly, the transactions of the interval difference subset(s) occur weekly (or within a suitable threshold of being weekly).

In some embodiments, the cash flow forecast engine 110 determines a plurality of interval difference subsets. The plurality of interval difference subsets (collectively) represents all of the transaction associated with the interval difference set. Each subset may represent only a single transaction on any given transaction date. Each transaction represented by a subset may be unique to that subset; a given transaction may not be represented by more than one subset. In other words, each transaction associated with an interval difference of the interval difference subsets may be associated or represented by only one of the subsets. And transactions that occur on a same transaction date are associated with or represented by different respective subsets.

For example, where the interval difference set is (7,0,7,0), five transactions are represented, with the second and third transactions occurring on a same transaction date, and the fourth and fifth transactions occurring on a same transaction date. Accordingly, at least two different possible interval difference subsets may be determined from the set: a first subset having the interval subset (7,7) and being associated with the first, second and fourth transactions, and a second subset having the interval subset (7) and being associated with the third and fifth transactions.

Accordingly, in some embodiments, the cash flow forecast engine 110 determines a first subset of interval difference set. The first subset is associated with or representative of, at most, a single transaction for any given transaction date. In response to determining that the interval difference set is representative of two transactions on a same transaction date (for example, an interval difference of zero or less than a threshold value), the cash flow forecast engine 110 determines a second subset of the interval difference set. In such an embodiment, the first transaction of the two same date transactions is represented by the first subset, and the second transaction of the two same date transactions is represented by the second subset. In some embodiments, the first and second subsets are mutually exclusive with respect to the transactions they represent, in that a transaction represented by the first subset cannot be represented by the second subset; each transaction is used only once.

In some embodiments, compliance with the transaction interval pattern is performed before, at the same times as, or after determining possible subsets. In some embodiments, compliance with the clustering criteria is performed before, at the same times as, or after determining possible subsets.

At 708, the cash flow forecast engine 110 determines the cluster(s) of transactions as the transactions of the subset of related transaction that are associated with the respective interval difference subset(s).

An experiment was conducted on a dataset containing transactions randomly sampled from 100,000 organisations. The experiment involved performing method 500 including method 700, as discussed above. The median coverage achieved was 0.285 and the median coverage achieved was 0.096.

Referring now again to FIG. 5, at step 516, the cash flow forecast engine 110 may determine if the cluster identified at step 510 was a viable cluster, based on the checks performed at step 514. According to some embodiments, the cluster may be deemed unviable if it fails at least one of the described checks. If the cluster is determined to be unviable, the cash flow forecast engine 110 moves to step 520, as described in further detail below.

If, at step 516, the cash flow forecast engine 110 determines that a viable cluster was formed, the cash flow forecast engine 110 moves to step 518. At step 518, the cash flow forecast engine 110 adds the transactions forming the viable cluster to the subset of transactions that will be output at step 528, to be further processed at step 406 of method 400, as described above. The cash flow forecast engine 110 also marks the transactions as “used”, so that these transactions are not re-used in future clustering attempts.

At step 520, the cash flow forecast engine 110 determines whether there exist further clustering criteria as described above with reference to step 508 that have yet to be used. If the cash flow forecast engine 110 determines that there do exist further clustering criteria, the cash flow forecast engine 110 subsequently performs step 522.

At step 522, the cash flow forecast engine 110 selects a different clustering criteria to be used for the clustering step at 510. According to some embodiments, the cash flow forecast engine 110 may select at least one clustering criteria that is more lenient than the previous clustering criteria used at step 510. Once the clustering criteria has been selected, cash flow forecast engine 110 returns to step 510 to re-cluster the transactions in an attempt to identify new viable clusters. By iterating through steps 510 to 522 and selecting more lenient clustering criteria each time, transactions that meet stricter clustering criteria can be identified and marked as used, increasing the chance that each transaction is allocated to the cluster that it fits best. According to some embodiments, only transactions marked as used, or transactions that have already been determined to make up a viable cluster, are not included in further iterations, meaning that any transactions previously clustered where the cluster was ultimately found to be unviable are included in the next clustering iteration at step 510.

If the cash flow forecast engine 110 determines that there do not exist further clustering criteria, the cash flow forecast engine 110 subsequently performs step 524. At step 524, the cash flow forecast engine 110 determines whether there exist further interval patterns as described above with reference to step 506 that have yet to be used. If the cash flow forecast engine 110 determines that there do exist further interval patterns, the cash flow forecast engine 110 subsequently performs step 526.

At step 526, the cash flow forecast engine 110 selects a different interval pattern to be used for the clustering step at 510. According to some embodiments, the cash flow forecast engine 110 may select an interval pattern that is longer in duration than the previous interval pattern used at step 510. For example, a first interval pattern may be “weekly”, a second and subsequent interval pattern may be “fortnightly”, a third and subsequent to the second interval pattern may be “monthly”, and so on. Once the interval pattern has been selected, cash flow forecast engine 110 returns to step 508 to select clustering criteria and subsequently re-cluster the transactions in an attempt to identify new viable clusters. By iterating through steps 506 to 526 and selecting longer interval patterns each time, transactions that meet shorter interval patterns can be identified and removed from the dataset, decreasing the chance that a recurring transaction with a short recurrence interval is misidentified as being part of a group of recurring transactions with a longer recurrence interval. According to some embodiments, only transactions marked as used, or transactions that have already been determined to make up a viable cluster, are not included in further iterations, meaning that any transactions previously clustered where the cluster was ultimately found to be unviable are included in the next clustering iteration at step 510.

If the cash flow forecast engine 110 determines that there do not exist further interval patterns, the cash flow forecast engine 110 may instead perform step 527. At step 527, the cash flow forecast engine 110 determines whether there exist further groups of transactions as described above with reference to steps 502 and 504 that have yet to be processed. If the cash flow forecast engine 110 determines that there do exist further groups, the cash flow forecast engine 110 subsequently performs step 530.

At step 530, cash flow forecast engine 110 selects the next identified group of transactions as identified at step 502, and returns to step 506 to select a first interval pattern for the new group.

If the cash flow forecast engine 110 determines that there do not exist further groups of transactions to process, the cash flow forecast engine 110 may instead perform step 528. At step 528, cash flow forecast engine 110 may output each of the subsets of viable transactions determined at step 518 for further processing, as described above with reference to step 406 of method 400. The identified subsets may be processed as described above with reference to FIG. 4 to generate models of periodic transactions and predict one or more future transactions.

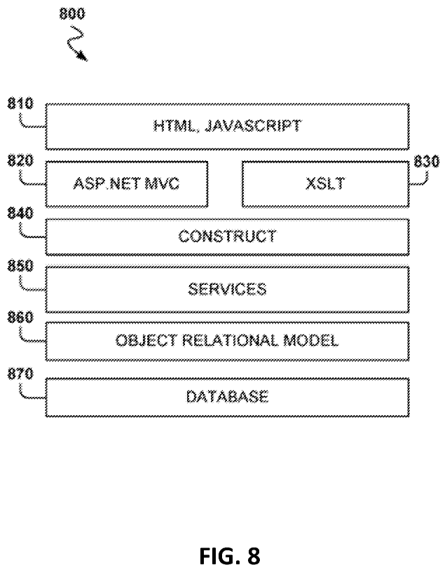

FIG. 8 is a block diagram depicting an example application framework 800, according to some embodiments. The application framework 800 may be an end-to-end web development framework enabling a “software as a service” (SaaS) product. The application framework 800 may include a hypertext markup language (HTML) and/or JavaScript layer 810, ASP.NET Model-View-Controller (MVC) 820, extensible stylesheet language transformations (XSLT) 830, construct 840, services 850, object relational model 860, and database 870.

The HTML and/or JavaScript layer 810 provides client-side functionality, such as user interface (UI) generation, receipt of user input, and communication with a server. The client-side code may be created dynamically by the ASP.NET MVC 820 or the XSLT 830. Alternatively, the client-side code may be statically created or dynamically created using another server-side tool. The ASP.NET MVC 820 and XSLT 830 provide server-side functionality, such as data processing, web page generation, and communication with a client. Other server-side technologies may also be used to interact with the database 870 and create an experience for the user.

The construct 840 provides a conduit through which data is processed and presented to a user. For example, the ASP.NET MVC 820 and XSLT 830 can access the construct 840 to determine the desired format of the data. Based on the construct 840, client-side code for presentation of the data is generated. The generated client-side code and data for presentation is sent to the client, which then presents data. In some example embodiments, when the MLP is invoked to analyze an entry, the MVC website makes an HTTP API call to a Python-based server. Also, the MVC website makes another HTTP API call to the Python-based server to present the suggestions to the user. The services 850 provide reusable tools that can be used by the ASP.NET 820, the XSLT 830, and the construct 840 to access data stored in the database 870. For example, aggregate data generated by calculations operating on raw data stored in the database 870 may be made accessible by the services 850.

The object relational model 860 provides data structures usable by software to manipulate data stored in the database 870. For example, the database 870 may represent a many-to-one relationship by storing multiple rows in a table, with each row having a value in common. By contrast, the software may prefer to access that data as an array, where the array is a member of an object corresponding to the common value. Accordingly, the object relational model 860 may convert the multiple rows to an array when the software accesses them and perform the reverse conversion when the data is stored.

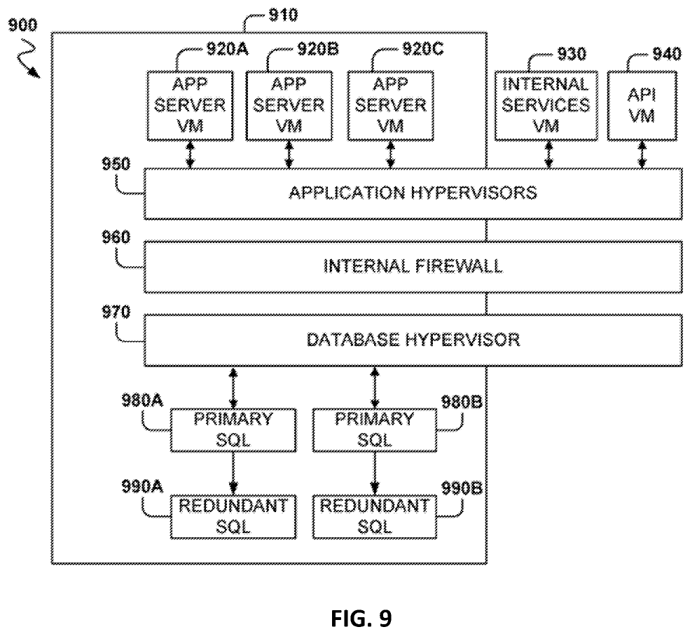

FIG. 9 is a block diagram depicting an example hosting infrastructure 900, according to some embodiments. The platform 600 may be implemented using one or more pods 910. Each pod 910 includes application server virtual machines (VMs) 920 (shown as application server virtual machines 920A-920C in FIG. 7) that are specific to the pod 910 as well as application server virtual machines that are shared between pods 910 (e.g., internal services VM 930 and application protocol interface VM 940). The application server virtual machines 920-940 communicate with clients and third-party applications via a web interface or an API. The application server virtual machines 920-940 are monitored by application hypervisors 950. In some example embodiments, the application server virtual machines 920A-920C and the API VM 940 are publicly accessible while the internal services VM 930 is not accessible by machines outside of the hosting infrastructure 900. The app server VMs 920A-920C may provide end-user services via an application or web interface. The internal services VM 930 may provide back-end tools to the app server VMs 920A-920C, monitoring tools to the application hypervisors 950, or other internal services. The API VM 940 may provide a programmatic interface to third parties. Using the programmatic interface, the third parties can build additional tools that rely on the features provided by the pod 910. An internal firewall 960 ensures that only approved communications are allowed between the database hypervisor 970 and the publicly accessible virtual machines 920-940. The database hypervisor 970 monitors the primary SQL servers 980A and 980B and the redundant SQL servers 990A and 990B. The virtual machines 920-940 can be implemented using Windows 8008 R2, Windows 8012, or another operating system. The support servers can be shared across multiple pods 910. The application hypervisors 950, internal firewall 960, and database hypervisor 970 may span multiple pods 910 within a data centre.

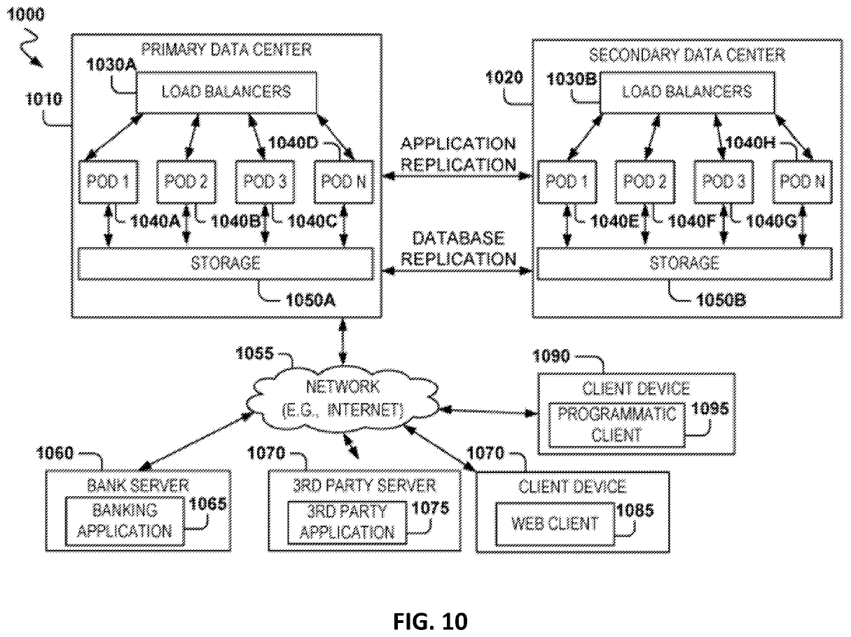

FIG. 10 is a block diagram depicting an example data centre system 1000 for implementing embodiments. The primary data centre 1010 services customer requests and is replicated to the secondary data centre 1020. The secondary data centre 1020 may be brought online to serve customer requests in case of a fault in the primary data centre 1010. The primary data centre 1010 communicates over a network 1055 with bank server 1060, third party server 1070, client device 1070, and client device 1090. The bank server provides banking data (e.g., via a banking application 1065). The third-party server 1070 is running third party application 1075. Client devices 1080 and 1090 interact with the primary data centre 1010 using web client 1085 and programmatic client 1095, respectively. Within each data centre 1010 and 1020, a plurality of pods, such as the pod 910 of FIG. 7, are shown. The primary data centre 1010 is shown containing pods 1040a-1040d. The secondary data centre 1020 is shown containing pods 1040e-1040h. The applications running on the pods of the primary data centre 1010 are replicated to the pods of the secondary data centre 1020. For example, EMC replication (provided by EMC Corporation) in combination with VMWare site recovery manager (SRM) may be used for the application layer replication. The database layer handles replication between a storage layer 1050a of the primary data centre and a storage layer 1050b of the secondary data centre. Database replication provides database consistency and the ability to ensure that all databases are at the same point in time. The data centres 1010 and 1020 use load balancers 1030a and 1030b, respectively, to balance the load on the pods within each data centre. The bank server 1060 interacts with the primary data centre 1010 to provide bank records for bank accounts of the client. For example, the client may provide account credentials to the primary data centre 1010, which the primary data centre 1010 uses to gain access to the account information of the client.

The bank server 1060 can provide the banking records to the primary data centre 1010 for later reconciliation by the client using the client device 1080 or 1090. The third-party server 1070 may interact with the primary data centre 1010 and the client device 1080 or 1090 to provide additional features to a user of the client device 1080 or 1090.

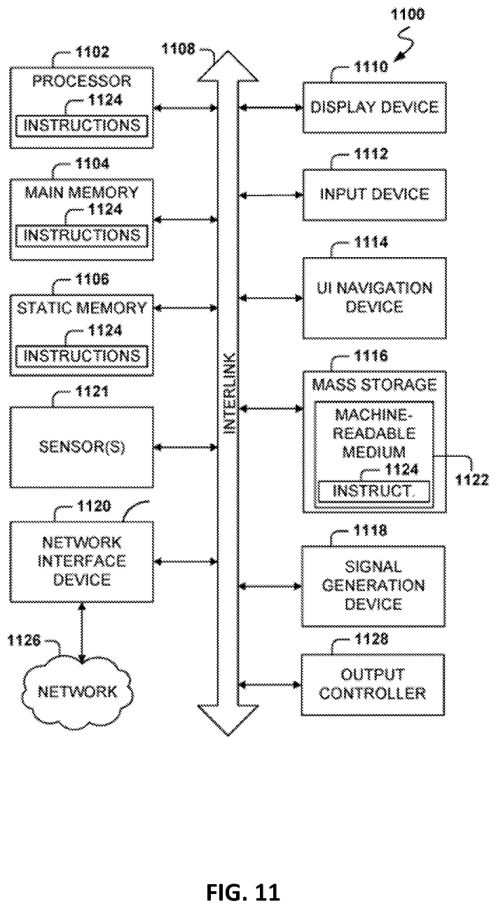

FIG. 11 is a block diagram illustrating an example of a machine upon which one or more example embodiments may be implemented. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a laptop, a mobile telephone, a web appliance, a network router, switch or bridge, or any machine capable of executing instructions (sequential or otherwise) that specify actions to be taken by that machine. Further, while only a single machine 1100 is illustrated, the term “machine” shall also be taken to include any collection of machines that individually or jointly execute a set (or multiple sets) of instructions to perform any one or more of the methodologies discussed herein, such as cloud computing, SaaS, or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1100 may include a hardware processor 1102 (e.g., a central processing unit (CPU), a graphics processing unit (GPU), a hardware processor core, or any combination thereof), a main memory 1104, and a static memory 1106, some or all of which may communicate with each other via an interlink (e.g., bus) 1108. The machine 1100 may further include a display device 1110, an alphanumeric input device 1112 (e.g., a keyboard), and a UI navigation device 1114 (e.g., a mouse). In an example, the display device 1110, input device 1112, and UI navigation device 1114 may be a touch screen display. The machine 1100 may additionally include a mass storage device (e.g., drive unit) 1116, a signal generation device 1118 (e.g., a speaker), a network interface device 1120, and one or more sensors 1121, such as a global positioning system (GPS) sensor, compass, accelerometer, or another sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions 1124 for execution by the machine 1100 and that cause the machine 1100 to perform any one or more of the techniques of the present disclosure, or that is capable of storing, encoding or carrying data structures used by or associated with such instructions 1124. Non-limiting machine-readable medium examples may include solid-state memories, and optical and magnetic media. In an example, a massed machine-readable medium comprises a machine-readable medium 1122 with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only

Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1102.11 family of standards known as Wi-Fi®, IEEE 1102.16 family of standards known as WiMax®), IEEE 1102.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126.

In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method comprising:
determining a dataset of transactions occurring during a first time period;
determining a subset of related transactions from the dataset of transactions, where each transaction in the subset of related transactions shares at least one common attribute;
selecting a first transaction interval pattern;
selecting a first clustering criteria, wherein the first clustering criteria comprises a threshold deviation from the first transaction interval pattern;
based on the first transaction interval pattern and the first clustering criteria, identifying a cluster of transactions from the subset of related transactions;
wherein identifying the cluster of transactions from the subset of related transactions comprises:
determining an interval difference between the dates of at least one pair of transactions in the subset of related transactions, and wherein each of the at least one pair of transactions comprises a first date having a first day and a first month, and a second date having a second day and a second month; and
determining the cluster of transactions as the transactions of the subset of related transactions that comply with the first transaction interval pattern and the threshold deviation from first transaction interval pattern; and
wherein determining the interval difference between the dates of at least one pair of transactions comprises:
determining a first interval difference value comprising a difference between the first day of the second month and the second day of the second month;
determining a second interval difference value comprising a difference between the second day of the first month and the first day of the first month;
determining a third interval difference value comprising a difference between the first day of the month following the first month and the second day of the second month;
determining a fourth interval difference value comprising a difference between the first day of the first month and the second day of the month immediately preceding the second month; and
determining the interval difference based on the first interval difference value, the second interval difference value, the third interval difference value and the fourth interval difference value; and
generating a model of periodic transactions based on the cluster of transactions, the model including an interval related to the first transaction interval pattern, and a common model attribute based on the at least one common attribute.

2. (canceled)

3. The method of claim 1, wherein weekend days are discounted from contributing to the interval difference.

4. The method of claim 3, wherein determining the interval difference between the dates of at least one pair of transactions in the subset of related transactions comprises, for each pair of the at least one pair of transactions:
determining a first date of a first transaction of the pair, the first date comprising a first day and a first month;
determining a second date of a second transaction of the pair, the second date comprising a second day and a second month; and
determining the interval difference based on the first date and the second date of the pair of transactions.

5. The method of claim 4, wherein determining the interval difference based on the first date and the second date of the pair of transactions comprises:
determining a first interval difference value comprising a difference between the first day of the second month and the second day of the second month;
determining a second interval difference value comprising a difference between the second day of the first month and the first day of the first month; and
determining the interval difference based on the first interval difference value and the second interval difference value.

6. The method of claim 4, wherein determining the interval difference based on the first date and the second date of the pair of transactions comprises:
determining a third interval difference value comprising a difference between the first day of the month following the first month and the second day of the second month;
determining a fourth interval difference value comprising a difference between the first day of the first month and the second day of the month immediately preceding the second month; and
determining the interval difference based on the third interval difference value and the fourth interval difference value.

7. The method of claim 4, wherein determining the interval difference comprises determining a minimum of the first interval difference value and the second interval difference value.

8. The method of claim 6, wherein determining the interval difference comprises determining a minimum of the third interval difference value and the fourth interval difference value as the interval difference.

9. The method of claim 6, wherein determining the interval difference based on the first date and the second date of the pair of transactions comprises:
determining a first interval difference value comprising a difference between the first day of the second month and the second day of the second month;
determining a second interval difference value comprising a difference between the second day of the first month and the first day of the first month; and
determining the interval difference based on the first interval difference value and the second interval difference value; and
wherein determining the interval difference comprises determining a minimum of the first interval difference value, the second interval difference value, the third interval difference value and the fourth interval difference value as the interval difference.

10. (canceled)

11. (canceled)

12. (canceled)

13. The method of claim 1, further comprising:
performing a viability check on the cluster; and
in response to the cluster passing the viability check, generating the model of periodic transactions.

14. The method of claim 1, further comprising marking the transactions of the cluster as used.

15. (canceled)

16. The method of claim 14, further comprising:
selecting a second transaction interval pattern, the second transaction interval pattern being longer in duration than the first transaction interval pattern;
based on the second transaction interval pattern and the first clustering criteria, identifying a further cluster of transactions from the subset of related transactions that are not marked as used;
performing a viability check on the further cluster; and
in response to the further cluster passing the viability check, generating a model of periodic transactions, the model including an interval related to the second transaction interval pattern, and a common attribute based on the at least one common attribute.

17. The method claim 1, further comprising using the model of periodic transactions to predict at least one future recurring transaction having an interval related to the second transaction interval pattern and a common attribute based on the at least one common attribute.

18. The method of claim 13, wherein performing a viability check on the cluster comprises checking one or more of: a recency of the latest transaction in the cluster; an extent to which the individual transaction intervals of the cluster match a determined pattern; and a number of unique transactions in the cluster.

19. A system comprising:
one or more processors; and
memory comprising computer executable instructions, which when executed by the one or more processors, cause the system to perform operations including:
determining a dataset of transactions occurring during a first time period;
determining a subset of related transactions from the dataset of transactions, where each transaction in the subset of related transactions shares at least one common attribute;
selecting a first transaction interval pattern;
selecting a first clustering criteria, wherein the first clustering criteria comprises a threshold deviation from the first transaction interval pattern;
based on the first transaction interval pattern and the first clustering criteria, identifying a cluster of transactions from the subset of related transactions;
wherein identifying the cluster of transactions from the subset of related transactions comprises:
determining an interval difference between the dates of at least one pair of transactions in the subset of related transactions, and wherein each of the at least one pair of transactions comprises a first date having a first day and a first month, and a second date having a second day and a second month; and
determining the cluster of transactions as the transactions of the subset of related transactions that comply with the first transaction interval pattern and the threshold deviation from first transaction interval pattern; and
wherein determining the interval difference between the dates of at least one pair of transactions comprises:
determining a first interval difference value comprising a difference between the first day of the second month and the second day of the second month;
determining a second interval difference value comprising a difference between the second day of the first month and the first day of the first month;
determining a third interval difference value comprising a difference between the first day of the month following the first month and the second day of the second month;
determining a fourth interval difference value comprising a difference between the first day of the first month and the second day of the month immediately preceding the second month; and
determining the interval difference based on the first interval difference value, the second interval difference value, the third interval difference value and the fourth interval difference value; and
generating a model of periodic transactions based on the cluster of transactions, the model including an interval related to the first transaction interval pattern, and a common model attribute based on the at least one common attribute.

20. A non-transitory machine-readable medium storing instructions which, when executed by one or more processors, cause a computing device to perform operations including:
determining a dataset of transactions occurring during a first time period;
determining a subset of related transactions from the dataset of transactions, where each transaction in the subset of related transactions shares at least one common attribute;
selecting a first transaction interval pattern;
selecting a first clustering criteria, wherein the first clustering criteria comprises a threshold deviation from the first transaction interval pattern;
based on the first transaction interval pattern and the first clustering criteria, identifying a cluster of transactions from the subset of related transactions;
wherein identifying the cluster of transactions from the subset of related transactions comprises:
determining an interval difference between the dates of at least one pair of transactions in the subset of related transactions, and wherein each of the at least one pair of transactions comprises a first date having a first day and a first month, and a second date having a second day and a second month; and
determining the cluster of transactions as the transactions of the subset of related transactions that comply with the first transaction interval pattern and the threshold deviation from first transaction interval pattern; and
wherein determining the interval difference between the dates of at least one pair of transactions comprises:
determining a first interval difference value comprising a difference between the first day of the second month and the second day of the second month;
determining a second interval difference value comprising a difference between the second day of the first month and the first day of the first month;
determining a third interval difference value comprising a difference between the first day of the month following the first month and the second day of the second month;
determining a fourth interval difference value comprising a difference between the first day of the first month and the second day of the month immediately preceding the second month; and
determining the interval difference based on the first interval difference value, the second interval difference value, the third interval difference value and the fourth interval difference value; and
generating a model of periodic transactions based on the cluster of transactions, the model including an interval related to the first transaction interval pattern, and a common model attribute based on the at least one common attribute.

21. The system of claim 19, wherein weekend days are discounted from contributing to the interval difference.

22. The system of claim 19, wherein determining the interval difference between the dates of at least one pair of transactions in the subset of related transactions comprises, for each pair of the at least one pair of transactions:
determining a first date of a first transaction of the pair, the first date comprising a first day and a first month;
determining a second date of a second transaction of the pair, the second date comprising a second day and a second month; and
determining the interval difference based on the first date and the second date of the pair of transactions.

23. The system of claim 19, wherein determining the interval difference based on the first date and the second date of the pair of transactions comprises:
determining a first interval difference value comprising a difference between the first day of the second month and the second day of the second month;
determining a second interval difference value comprising a difference between the second day of the first month and the first day of the first month; and
determining the interval difference based on the first interval difference value and the second interval difference value.

24. The non-transitory machine-readable medium of claim 20, wherein weekend days are discounted from contributing to the interval difference.

25. The non-transitory machine-readable medium of claim 20, wherein determining the interval difference between the dates of at least one pair of transactions in the subset of related transactions comprises, for each pair of the at least one pair of transactions:
determining a first date of a first transaction of the pair, the first date comprising a first day and a first month;
determining a second date of a second transaction of the pair, the second date comprising a second day and a second month; and
determining the interval difference based on the first date and the second date of the pair of transactions.
